(19) United States
(12) Patent Application Publication
(10) Pub. No.: US 2006/0218114 A1
(43) Pub. Date: Sep. 28, 2006

(54) System and method for location based search

(75) Inventors: Christopher Weare, Bellevue, WA (US); Ashley Feniello, Carnation, WA (US); Randy Kern, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/089,328

(22) Filed: Mar. 25, 2005

(51) Int. Cl. G06F 17/30

(52) U.S. Cl. 707/1

(57) ABSTRACT

A system and method for performing geographic based document searching. A grid of location tiles is constructed corresponding to a desired geographic area. A location tag is assigned to each location tile. Documents are searched to identify a geographic location. The documents are associated with one or more location tags based on the location tiles corresponding to the identified geographic location. The geographic location of a search query is also identified. The search query is modified to include one or more location tags corresponding to the location of the search query. The search query is then matched to documents associated with location tags contained in the search query.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates to a method for performing geographic based document searches.

### BACKGROUND OF THE INVENTION

Many types of internet searches are implicitly locality based. For example, when a user types in a search query such as “pizza delivery”, the user typically wants to locate pizza delivery services that are near to the user's geographical location. In other words, the user would prefer results for the search query “pizza delivery near me.”

Some conventional search engines for searching documents (such as Internet web pages) have the capability to rank search results based on a distance between a location specified by the document and a location specified by the user. However, calculating the distance between two locations is a computationally intensive activity for a search engine, leading to slow response times for conventional search engines.

What is needed is a system and method of performing geographic based searches while maintaining the fast response times of conventional search methods. The system and method should be compatible with conventional search techniques. The system and method should also be flexible enough to accommodate varying definitions of geographic proximity.

### SUMMARY OF THE INVENTION

This invention provides a system and method for performing geographic based searches while maintaining fast response times. The system and method are compatible with existing search engine technology.

In an embodiment, the invention provides a method for indexing a document based on keywords that correspond to geographic area. In this embodiment, one or more geographic grids of location tiles is constructed, each location tile having a location tag that identifies the location tile. After constructing the one or more grids, documents are searched to identify geographic locations in the document. If a geographic location is identified for a document, the document is associated with a location tag corresponding to the location tile containing the identified geographic location. In another embodiment, documents can also be associated with location tags corresponding to the nearest neighbor location tiles of the identified geographic location.

In an embodiment, the indexed documents can be matched to search queries that contain one or more location tags, including search queries that are modified to include a location tag. Preferably, the location tags in a search query correspond to a search query location. Any matching documents can be provided as a response to the search query.

The method also provides a method for performing a geographic based document search. In an embodiment, a geographic location is determined for a search query. The search query is modified to include a location tag corresponding to a location tile containing the geographic location of the search query. The search query is then matched with one or more documents associated with the location tag. In an embodiment, any matching documents can be provided as a response to the search query. In such an embodiment, the actual distance between the document location and the search query location can be calculated. Documents provided in response to the search query can be prioritized based on the distance calculation, or the documents can be prioritized based on the number and type of location tag matches with the search query.

In another embodiment, the method also includes searching documents prior to receiving the search query in order to identify geographic locations for the documents. The documents are associated with location tags corresponding to the identified geographic locations. These pre-searched documents are then matched to search queries as described above.

The invention further provides a system for performing geographic based document searches. In an embodiment, the system comprises a search engine that also includes a grid builder for constructing a grid of location tiles corresponding to a geographic area. The system also includes a location tag assignment mechanism for assigning location tags to the location tiles. The system further includes a location association mechanism for identifying geographic locations in documents and associating the documents with location tags corresponding to the location tiles containing the identified geographic locations.

In various embodiments, the system can also include a search query modification mechanism for determining a geographic location for a search query and then modifying the search query to include a location tag corresponding to a location tile containing the search query location. In still other embodiments, the system can include a document indexing mechanism for storing associations between location tags and documents; a keyword matching mechanism for matching a document associated with a location tag to a search query; and a distance calculator for determining distances between document locations and search query locations.

### BRIEF DESCRIPTION OF THE DRAWINGS

FIG. 1 is a block diagram illustrating an overview of a system in accordance with an embodiment of the invention;

FIG. 2 is block diagram illustrating a computerized environment in which embodiments of the invention may be implemented;

FIG. 3 is a block diagram of a geographic grid construction module in accordance with an embodiment of the invention;

FIG. 4 depicts location tiles arranged over a geographic area according to an embodiment of the invention;

FIG. 5 is a flow chart illustrating a method for geographically indexing documents according to an embodiment of the invention; and

FIG. 6 is a flow chart illustrating a method for performing a geographic based search according to an embodiment of the invention.

### DETAILED DESCRIPTION OF THE EMBODIMENTS

I. Overview

This invention provides a method for improving the response time for locality or geographic based electronic document queries. The method can allow for strict searching, where only documents within a specified geographic area or locality are included. Alternatively, the method can be used to preferentially rank search results, where locality only changes the relative ranking of a document that matches one or more other terms in a search query.

In various embodiments, the invention improves the response time for responding to a locality based search query by determining geographic proximity using pre-assigned location tags. By using the pre-assigned location tags, the search algorithm does not have to perform an expensive distance calculation for each document identified in a search. Instead, the distance calculation can either be avoided entirely, or selectively performed for those search results that are known to be in close proximity to the location of the user providing the search query. The assignment of the location tags can be performed any time before the user submits the search request. By pre-searching the documents to assign location tags, the amount of calculation required when a user submits a search request is minimized.

The improved method for locality or geographic based searching begins by assigning location tags to regions of a geographic area. A grid is placed over the geographic area, and the individual elements of the grid, or location tiles, are assigned location tags. The location tags are text strings that represent the location tiles in the geographic area. In an embodiment, the text string can include identifying information for the location tile, such as latitude and longitude information. A grid is not exclusive, so more than one grid can be placed over a geographic area, which would result in multiple location tiles (and thus location tags) that correspond to the same geographic area.

Once location tags have been assigned to the geographic grid elements, the location tags are associated with any searchable documents that could potentially be the target of a search query. In an embodiment, this is accomplished by searching the documents to determine if the document corresponds to any geographic locations. When a geographic location can be identified for a document, any location tags corresponding to that geographic location are associated with the document.

After associating documents with location tags, the location of a document can be matched to a search query location as if the search query location was one or more search terms. In various embodiments, when a user types in a search query, the desired location for the search query is determined. One or more location tags corresponding to the desired location in the search query are then identified. These identified location tags, which are text strings, are added to the search query and treated like any other terms in the search query. A document search is then performed to find documents matching the search terms in the modified search query. Any documents associated with one or more of the location tags in the modified search query will be considered as matching a term of the search. Documents which match based on the location tag can either be included in the search based on the match, and/or can be given a preferentially higher ranking when the search results are displayed to the user. Optionally, once a document is identified by matching a location tag in the modified search query, a distance calculation can be performed between the location of the search query and the geographic location of the document.

II. General Operating Environment

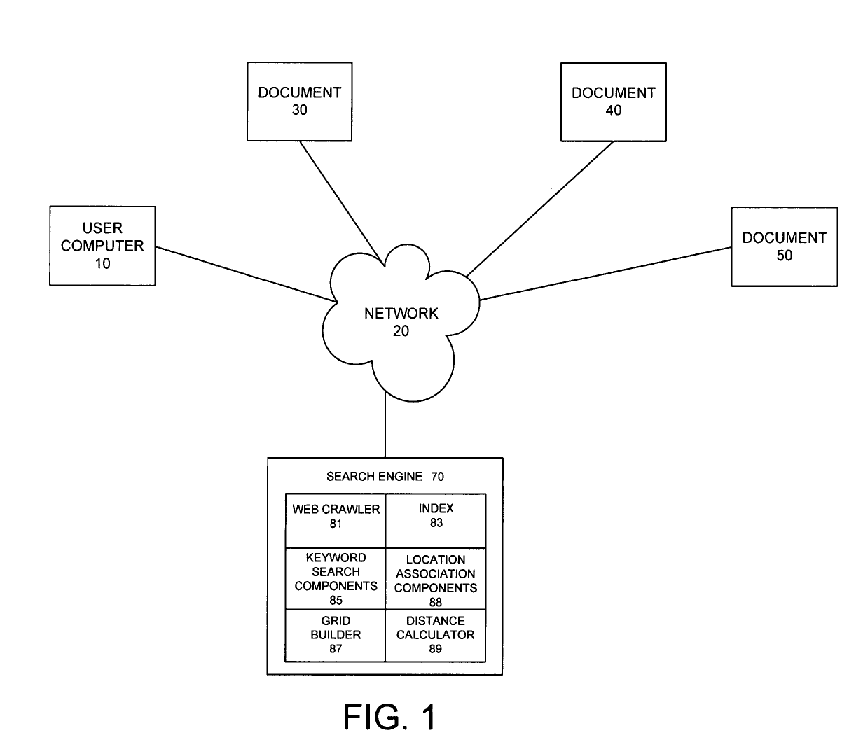

FIG. 1 illustrates a system for performing geographic based searches according to an embodiment of the invention. A user computer 10 may be connected over a network 20, such as the Internet, with a search engine 70. The search engine 70 may access multiple web sites 30, 40, and 50 over the network 20. This limited number of web sites is shown for exemplary purposes only. In actual applications the search engine 70 may access large numbers of web sites over the network 20.

The search engine 70 may include a web crawler 81 for traversing the web sites 30, 40, and 50 and an index 83 for indexing the traversed web sites. The search engine 70 may also include a keyword search component 85 for searching the index 83 for results in response to a search query from the user computer 10. The search engine 200 may also include a grid builder 87 for constructing a grid of location tiles over a geographic area and assigning location tags to the location tiles. Alternatively, grid builder 87 can be a separate program. A location association component 88 may be included to identify geographic locations in a document and associate the document with location tiles. The location association component can also associate a user location with corresponding location tiles. Distance calculator 89 allows the search engine to determine the distance between a user location and a document that has an identifiable geographic location.

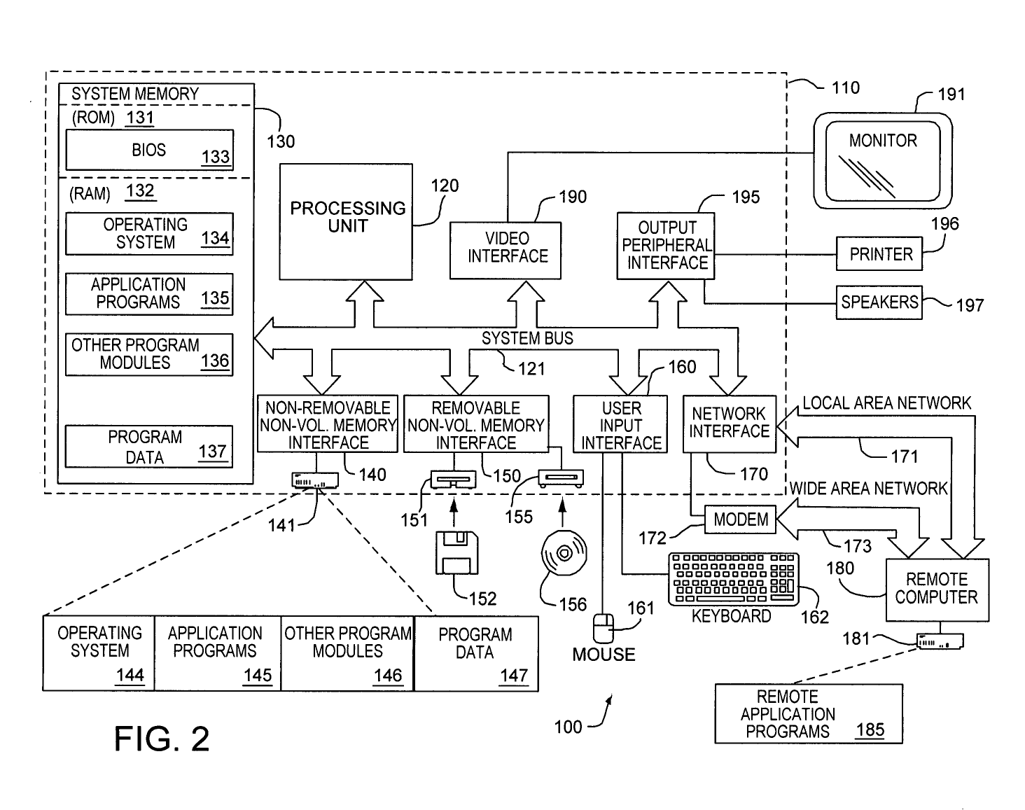

FIG. 2 illustrates an example of a suitable computing system environment 100 for implementing geographic based searching according to the invention. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. Forming Geographic Grids and Location Tiles

In various embodiments, a precursor step to performing the method of the invention is the formation of at least one grid over a geographic area. The grid is composed of grid elements or location tiles, which can be any combination of shapes which fill a 2-dimensional space. In an embodiment, the location tiles can be triangles, parallelpipeds, hexagons, or any other regular, space-filling shape in 2 dimensions. In another embodiment, the location tiles can have multiple shapes and dimensions that lead to filling of a 2-dimensional space. For example, the location tiles can be a combination of rectangles and squares of varying side dimensions. Alternatively, the location tiles could include shapes that cannot be used by themselves to fill a two-dimensional space, such as pentagons or heptagons. Still other irregular shapes can also be used, so long as the boundaries of the location tiles are clearly defined and each location tile has a clearly defined list of nearest neighbor location tiles within the grid.

In order to form a grid over a desired geographical area, the geographical area should be represented as a flat, 2-dimensional area. For example, to form a grid that covers an entire earth, the surface of the planet should be projected into 2 dimensions. Mercator projections and equidistant cylindrical projections are examples of how portions of the 3-dimensional shape of the earth can be projected into 2 dimensions.

To construct a grid, a starting point or line is selected. Location tiles are then arranged to fill a desired 2-dimensional geographic area. For example, a grid for a city could start by selecting the center of the city as a starting point. Location tiles could then be arranged to fill the geographic area corresponding to the city. In another example, the international date line can be selected as a starting line. Square or rectangular location tiles can then be used to fill the entire projected area of the globe.

Because the location tiles are arranged to fill a selected area, each location tile will have a list of “nearest neighbor” location tiles. In an embodiment, the nearest neighbor location tiles are the group of tiles that share a common boundary with a give location tile. For example, in a grid with square location tiles of uniform size, each location tile will have a total of eight nearest neighbor tiles. Similarly, in a grid of regular hexagons of uniform size, each location tile will have six nearest neighbor tiles. In some embodiments, location tiles located at the edge of a grid may have a lower number of nearest neighbors. Alternatively, to minimize edge effects, the grid can be constructed to encircle the earth. In this situation, although the 2-dimensional projection of the earth will produce a flat page, the right edge of the projection is actually adjacent to the left edge of the projection. Therefore, for a location tile located on the right edge of the grid, it is appropriate to include location tiles from the left edge of the grid in the nearest neighbor list, and vice versa. Those of skill in the art will recognize that other special cases can arise at the edges of the grid, and can be similarly handled by taking into account the true geography being represented by the 2-dimensional projection.

During or after formation of the grid, location tags are assigned to the location tiles. A location tag is a text string that identifies a location tile within a grid. The text string can be any combination of characters that can be used as a search term in a search query. In preferred embodiments the location tag includes identifying information about the location tile. In an embodiment, the location tag text string includes a mathematical identification of the geographic location, such as a latitude and longitude of a tile. In another embodiment where multiple grids are created, the location tag text string includes information that identifies the grid that a location tile belongs to. In still another embodiment, the location tag text string contains information about the shape and/or size of a location tile.

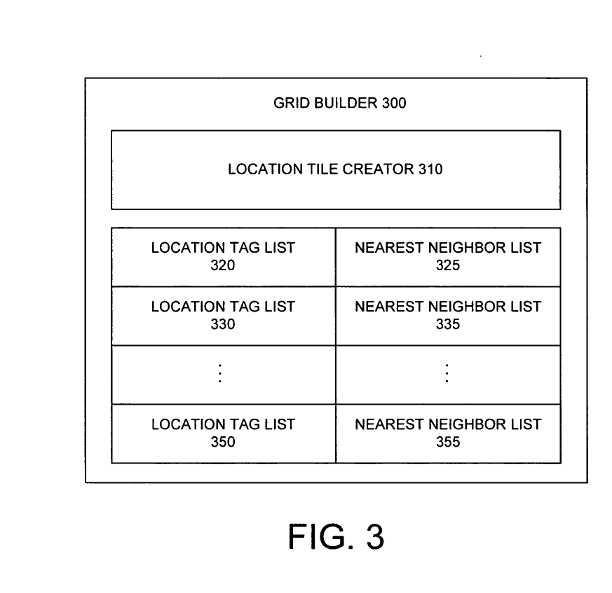

FIG. 3 schematically depicts a grid builder 300 according to an embodiment of the invention. Grid builder 300 includes a location tile creator 310 for constructing the initial space-filling grid of location tiles. In an embodiment, grid builder 300 also includes one or more pairs of location tag lists and nearest neighbor lists. A location tag list (such as location tag list 320, 330, and 350) contains the location tag identifiers for each location tile in a single grid. In an alternative embodiment, a single location tag list could contain all location tags for multiple grids. A nearest neighbor list (such as nearest neighbor list 325, 335, and 355) provides a listing of the nearest neighbor location tiles for each location tile in a grid. Although the location tag lists and nearest neighbor lists are shown here as data structures, in another embodiment the location tag for a location tile and the nearest neighbor location tiles can be calculated as needed. In such an embodiment, the creation location tags for the location tiles conforms to a pattern so that the location tag can be determined based using an algorithm. For example, the location tag for a location tile can be based on the latitude and longitude of the tile.

In an embodiment, multiple grids can be constructed that cover the same geographic area. The multiple grids can have the same or different starting points. The grids can also have different sizes and shapes for the location tiles. For example, multiple grids of the United States could be constructed to have location tiles with differing resolutions. The grid with smallest location tiles could have square tiles that correspond to 1 mile on each side. The other grids could be larger, with tiles that represent 5 miles on each side, 25 miles on each side, and 100 miles on each side. In another example, separate grids could have start points centered in Los Angeles and San Diego, respectively. Both grids could then be expanded to cover the entire area from Los Angeles to San Diego. If desired, the location tiles for the Los Angeles grid can be squares while the location tiles for the San Diego grid are hexagons.

IV. Pre-Searching Documents

During a pre-search, a group of searchable documents is searched to catalog the documents based on the search terms present within the document. The results of the pre-search can be stored in a convenient format or data structure that allows for rapid response to a search query.

One example of a data structure for holding pre-search results is an inverted index. An inverted index is a list of potential searchable terms and documents that contain those terms. When a document is pre-searched, the document is associated with each search term present in the document. The search terms can be individual words, groups of words, or any other string of characters that can be used as part of a search query. When a search term is used in a search query, the search term can be quickly found in the inverted index. Each document associated with the search term is returned as a match.

This invention will be further described below in an embodiment involving an inverted index for holding the results of a pre-search. This embodiment is only illustrative, however, and other data structures and/or methods for storing the results of a pre-search may also be used with this invention.

V. Associating Location Tiles with Documents

During a pre-search, the searchable documents can be associated with one or more location tiles. To associate a location tile with a document, the document is searched to determine if the document is associated with one or more geographic locations. Determining a geographic location for a document can be achieved by various methods. In an embodiment, a document is searched for geographic locations, such as city names, country names, street addresses, and/or zip codes. A document can also be searched for additional references that indicate a location, such as airports, government buildings, or other landmarks.

If the search of a document provides at least one geographic location, one or more location tiles containing the geographic location can be associated with the document. For example, if multiple grids have been formed that have different levels of grid resolution, a location tile from each grid will contain a geographic location. Similarly, if the document contains multiple geographic locations, more than one location tile from a single grid can be associated with the document. On the other hand, if the document does not include a geographic location, no location tile is associated with the document.

Location tiles are associated with documents by using the location tag assigned to each location tile. As described above, location tags are strings of characters suitable for inclusion in a search query. Each location tag is included in the data structure used to store the results of a pre-search. In the embodiment described here, the location tags are included in the inverted index that is used to store the pre-search results. The location tags are stored in the inverted index in the same manner as the other search terms in the index. Similarly, documents associated with a location tag are stored in the index in the same manner as documents associated with any other search term.

In another embodiment, association of a document with a location tile is more selective, in order to reduce or eliminate the number of “spam” documents associated with a location tile. A “spam” document refers to a document that mentions a geographic location solely for the purpose of being identified by a search, such as a document that simply recites a list of city names without having any other connection to the listed cities. In such an embodiment, multiple references to a location must be provided for the document to be associated with a location tile. For example, a document reciting the word “Seattle” would not be automatically associated with location tiles containing portions of the city of Seattle. Instead, the document would only be associated with location tiles for Seattle if the document contained other indicators, such as a Seattle zip code, the place name “Space Needle,” or other locations found in Seattle.

The process of searching documents continues until all desired searchable documents have been searched and associated with terms in the inverted index. The inverted index is now ready for use in responding to search queries. To maintain the inverted index, the process of pre-searching documents can be repeated periodically, such as daily, or weekly, or monthly, or yearly. In another embodiment, the inverted index can be updated according to any convenient schedule. In still another embodiment, the inverted index can be updated based on the occurrence of an event, such as when a sufficient number of new searchable documents become available for pre-searching.

VI. Adding Location Tags to the Search Query

In various embodiments of the invention, search queries provided by a user are modified to match a user location. The location of the user initiating a search query can be set or determined in various ways. In an embodiment, the user can include a location explicitly in a search query. This explicit location can then be used as the user location. In another embodiment, the user location can be previously set by the user. For example, if the user is registered or logged in to the search engine, a user profile may be available. An address associated with the user profile can be used as the user location. In still another embodiment, the location of the user performing a search of internet documents can be determined using reverse-IP lookup. A search query from an internet user will be associated with an IP address. The IP address corresponds to the “virtual location” where the user is accessing the internet. When a user submits a search query, the IP address of the user submitting the query can usually be identified. This IP address can then be submitted to an internet service that locates the physical location that corresponds to an IP address. If a physical location can be determined for the IP address, this physical location can be used as the user location.

In still another embodiment, the user location can be set by analyzing previous documents accessed by the user. In such an embodiment, any locations associated with previous documents accessed by a user are stored. A user location can then be determined by analyzing this history. For example, the history of document locations can be scanned to determine a most common city, a most common zip code, or another common geographic location. In a preferred embodiment, the history of document locations is stored based on the location tiles associated with documents, such as by storing the location tags. In such an embodiment, the user location can be assigned based on the stored location tags, such as by using the most common location tag. Other methods of assigning a user location will be apparent to those of skill in the art. In an embodiment, if no user location can be assigned, the search query is not modified.

Once a user location is assigned, any location tiles associated with the user location are identified. As with a document, the user location can be associated with a location tile for each grid constructed. For each location tile identified, the search query is modified to include one or more location tags. In an embodiment, for each location tile associated with a user location, the search query is modified to add the location tag assigned to that location tile. This location tag can be referred to as the search location tag.

In a preferred embodiment, multiple location tags are added to the search query for each location tile associated with the user location. In this embodiment, the search query is modified by adding the location tag for the location tile associated with the user location. In addition, the location tag for each nearest neighbor tile is also added to the search query. Adding the location tags for the nearest neighbor tiles accounts for the possibility that a document associated with a nearby geographic location might be located just across the boundary of a nearest neighbor location tile. In an alternative embodiment, this same function can be achieved when the inverted index is constructed during the pre-search. When a geographic location is identified for a document, the document can be associated with the location tile containing the geographic location as well as the nearest neighbor location tiles. This means that the document is also listed in the inverted index in association with the location tags for the nearest neighbor location tiles.

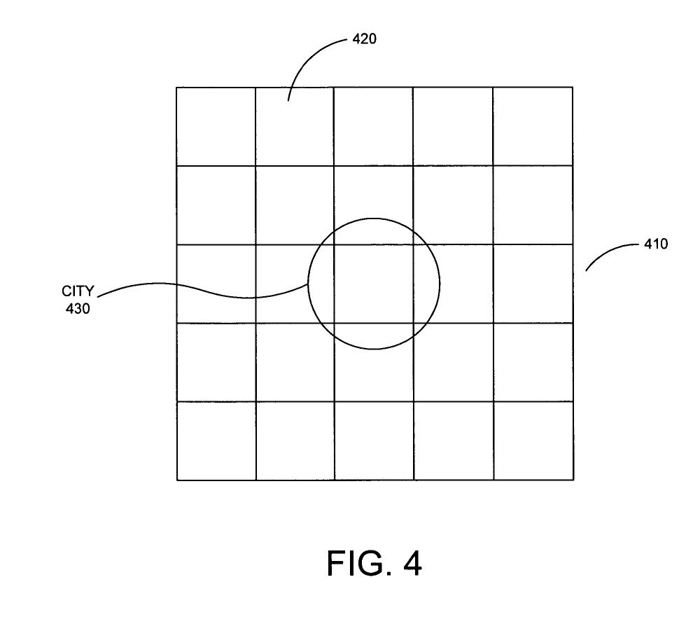

Note that in some embodiments, some grids may not include a location tile corresponding to a user location. FIG. 4 provides an example where two grids have been constructed in an area that includes a city. Grid 420 has square location tiles with a side length of five miles (the 5 mile grid). Grid 410 also has square location tiles, but the side length is 25 miles (the 25 mile grid). Note that in FIG. 4, only one location tile of grid 410 is displayed. In this example, the user location is known only to be within city 430. The city is larger than a 5 mile location tile of grid 410, but is entirely contained within a 25 mile location tile of grid 420. In this example, no location tile from grid 410 would be associated with the user location, because the user location is defined as being within a region larger than the individual location tiles of grid 410. However, the location tile from grid 420 containing the city would be associated with the user location. Therefore, the search query would be modified to include the appropriate location tag from the 25 mile grid.

VII. Matching Documents to a Search Query

Location tags added to a search query can be used to modify the response to the query in various ways. In an embodiment, the location tags are used as mandatory terms. Only documents that match the location tags in the search query are provided to the user as matches. In this embodiment, the location tags are treated similarly to other terms in the search query.

In another embodiment, the location tags in the search query are used only to prioritize the documents matching other terms in the search query. In such an embodiment, the matching the location tags in the search query does not include or exclude a document. Instead, documents which match a location tag are assigned an increased value in determining the order to display results to the user. For example, the priority value for displaying a document can be incremented for each location tag it matches. Alternatively, the increase in priority value for matching a location tile of a grid with smaller location tiles can be greater than the increase in priority value for matching a location tile in a coarser grid.

Another method for prioritizing search results is based on distance calculations. After identifying the documents which match the search query, a distance calculation can be performed on only these matching documents. In embodiments where the location tags are matched as mandatory terms, the distance calculation is only performed for documents matching the location tags. In this embodiment, adding location tags to the search query allows documents of interest to the user to be identified simply by looking up the documents in an inverted index (or other pre-search data structure). The more computationally expensive distance calculation is then performed only for the documents with matching location tags. In another embodiment, the location tag matches are used only to prioritize the display of documents matching other terms in the search query. In such an embodiment, the distance can be calculated only for documents with a matching location tag. In still another embodiment, the distance can be calculated for all documents with a sufficiently high priority. In this embodiment, some documents without a matching location tag may have a sufficiently high priority to have the distance calculation.

VIII. Exemplary Embodiment

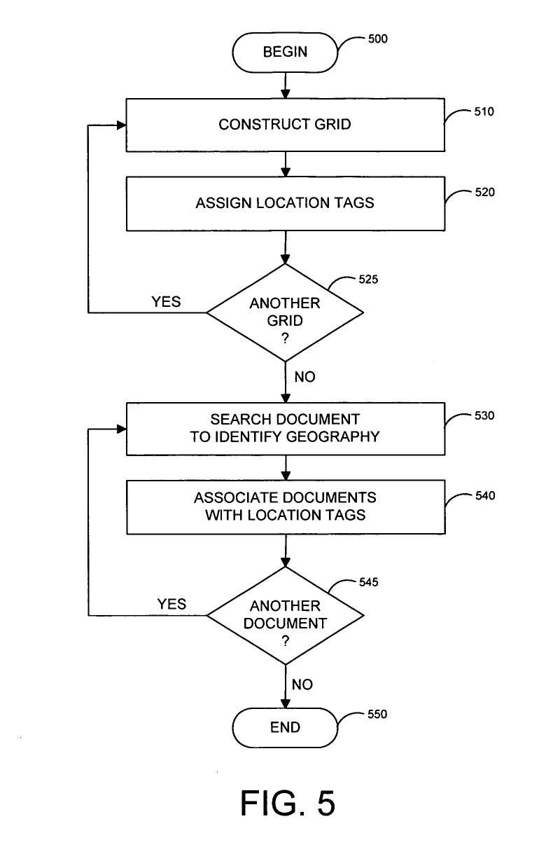

FIG. 5 depicts a flow chart for building a grid of location tiles and associating documents with the location tiles according to an embodiment of the invention. One method for constructing a grid 510 is to base the grid on lines of latitude and longitude. The equator provides a convenient reference for latitude, while the international date line can be used as the reference for longitude. Based on these selections, latitude and longitude coordinates can be quantized into location tiles using the following formulas:
qLatitude=Floor((latitude+90.0)·24902.0/360.0/R)
qLongitude=Floor((longitude+180.0)·d (latitude,0, latitude,1)/R)

In the formula for “qlatitude,” the function “Floor” returns the closest integer below its argument. ±90° is the maximum value of the latitude (corresponding to the north or south pole). 24902 is the approximate circumference of the earth in miles at the equator. 360 is the number of degrees in a circle. R is the desired degree of quantization. For example, if each location tile should be a 5 mile square, then R=5.

In the formula for “qlongitude,” the function “Floor” returns the closest integer below its argument. ±180° is the maximum value of the longitude. R is the desired degree of quantization (in miles). “d” is a function of the form:

d(latitude_a, longitude_a, latitude_b, longitude_b)

where the function “d” returns the distance between the two specified locations. As used in the equation for “qlongitude,” the values of longitude_a and longitude_b are 0 and 1, respectively. This calculates the distance between the 0 and 1 longitude points at the specified latitude. As used in the equation for “qlongitude,” the function “d” provides a scaling factor that accounts for the narrowing of the distance between longitude lines as the magnitude of the latitude increases (i.e., as one moves away from the equator).

Based on this definition, more than one grid can be constructed 525. In this example, square grids with sides of 1 mile, 5 miles, 25 miles, and 100 miles are constructed. The location tiles within each of these grids are assigned tags that are descriptive of the tile location. As an example, the city center of “Seattle, Wash.” is located at latitude 47.590000, longitude −122.33. The city center corresponds to a tile in each of the 4 grids. The tags assigned 520 with these location tiles are:

t100M00026L00095

t025M00107L00380

t005M00538L01903

t001M02690L09517

In assigning 520 each location tag, the first 3 digits after the “t” represents the resolution. The five digits after the “M” represent the quantized latitude, while the 5 digits after the “L” represent the quantized longitude. Note that FIG. 5 shows location tags being assigned after each grid is constructed. In another embodiment, the assignment of location tags can occur after the construction of all desired grids.

The location tags described above can now be associated with documents during a pre-search. During the pre-search, any geographic references in a document are identified 530. If a geographic location for a document can be determined, a location tag for each of the 4 grids is generated as described above. The document is then associated 540 with each of the location tags, such as by including the document in the inverted index entries for each location tag. This process is repeated 545 as needed for other documents that are pre-searched.

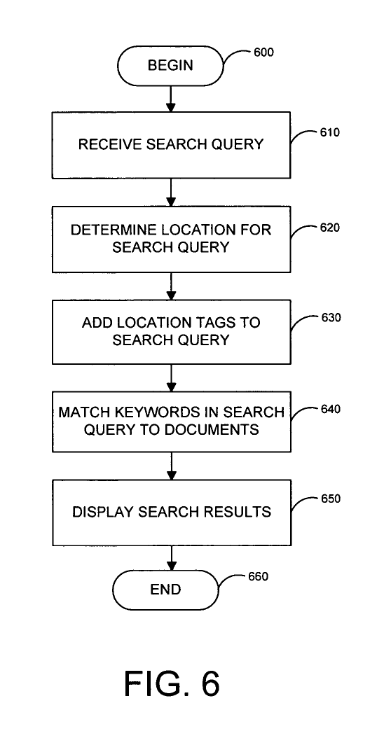

FIG. 6 depicts a method for returning search results to a user according to an embodiment of the invention. When a search query is received 610 by a search engine, a geographic location for the search query is determined 620. For example, the location of the search query contained in a cookie in the user's web browser. Based on the location of the search query, 4 location tags are generated using the formula described above. The 4 location tags are added 630 to the user's search query. In this example, the location tags are used to prioritize search results as opposed to requiring a match. If the user submitted the query “pizza” from the zip code containing the city center of Seattle, Wash., the query would be converted into

“pizza prefer:t100m00026100095 prefer:t025m00107100380 prefer:t005m00538101903 prefer:t001m02690109517”

The query can then be processed to identify documents containing the search term “pizza.” When the documents are shown to the user who initiated the search query, documents matching 640 one of the location tags will be displayed 650 at the beginning of the list using any of a variety of ranking methods. For example, the documents matching the most location tags could be listed first, or the documents matching the tag with the highest resolution could be listed first, or the documents could be ranked based on a distance calculation to the user's location.

Having now fully described this invention, it will be appreciated by those skilled in the art that the invention can be performed within a wide range of parameters within what is claimed, without departing from the spirit and scope of the invention.

What is claimed is:

1. A method of indexing a document, comprising:
constructing one or more geographic grids of location tiles, each location tile having a location tag;
searching a document to identify at least one geographic location; and
associating the searched document with a location tag corresponding to the location tile containing the identified geographic location.

2. The method of claim 1, further comprising:
matching the searched document with a search query containing the location tag.

3. The method of claim 2, further comprising providing the matched document in response to the search query

4. The method of claim 1, further comprising:
determining a geographic location for a search query;
modifying a search query by adding a search location tag, the search location tag corresponding to the geographic location of the search query;
matching the searched document with the modified search query.

5. The method of claim 4, further comprising calculating a distance between the identified geographic location of the document and the geographic location of the search query.

6. The method of claim 1, further comprising associating the searched document with one or more location tags corresponding to nearest neighbor location tiles of the location tile containing the identified geographic location.

7. A computer readable medium storing computer executable instructions for performing the method of claim 1.

8. A method for performing a document search, comprising:
determining a geographic location for a search query;
modifying the search query to include a location tag corresponding to a location tile containing the geographic location of the search query; and
matching the search query with one or more documents associated with the location tag.

9. The method of claim 8, further comprising providing the one or more matching documents in response to the search query.

10. The method of claim 9, further comprising calculating a distance between the geographic location of the search query and the one or more documents matching the search query.

11. The method of claim 10, where the matched documents are provided as a prioritized list.

12. The method of claim 11, wherein the matched documents are prioritized based on the distance calculation.

13. The method of claim 11, wherein the matched documents are prioritized based on the number of location tag matches for each document.

14. The method of claim 8, further comprising:
searching a document to identify at least one geographic location; and
associating the searched document with a location tag corresponding to the location tile containing the identified geographic location

15. A computer readable medium storing computer executable instructions for performing the method of claim 8.

16. A search engine for performing geographical based document searches comprising:
a grid builder for constructing a grid of location tiles corresponding to a geographical area;
a location tag assignment mechanism for assigning a location tag to each location tile; and
a location association mechanism for identifying a geographic location in a document and associating the document with one or more location tags corresponding to location tiles containing the identified geographic location.

17. The system of claim 16, further comprising a search query modification mechanism for determining a geographic location of a search query and modifying the search query to include a location tag corresponding to a location tile containing the search query location.

18. The system of claim 17, further comprising a document indexing mechanism for storing associations between location tags and searched documents.

19. The system of claim 16, further comprising a keyword matching mechanism for matching a document associated with a location tag to a search query.

20. The system of claim 16, further comprising a distance calculator.
